(19) United States
(12) Patent Application Publication
(10) Pub. No.: US 2025/0089597 A1
(43) Pub. Date: Mar. 20, 2025

(54) FARMING IMPLEMENT FOR DECOMPACTING SOIL

(71) Applicant: Camilo Ramos da Silva, São Carlos (BR)

(72) Inventor: Lucas Derick BORO, São Carlos (BR)

(21) Appl. No.: 18/468,224

(22) Filed: Sep. 15, 2023

(51) Int. Cl. A01B 79/00; A01B 49/02

(52) U.S. Cl. CPC A01B 79/005; A01B 49/027

(57) ABSTRACT

A farming implement for decompacting the soil in a growing environment of a perennial or annual farm crop. The main aspect that differentiates this implement from implements known in the state of the art is that the soil is decompacted selectively, based on a compaction map that enables, by the georeferenced position of the soil, operations at a greater or lesser depth, incorporating into one same implement the functions of a scarifier and a subsoiler.

### FIELD OF THE INVENTION

The present invention pertains to the field of farming machinery and implements, more specifically farming implements that decompact the soil in a growing environment of a perennial or annual farm crop. The main aspect that differentiates this implement from implements known in the state of the art is that the soil is decompacted selectively, based on a compaction map that enables, by the georeferenced position of the soil, operations at a greater or lesser depth, incorporating into one same implement the functions of a scarifier and a subsoiler.

### DESCRIPTION OF THE PRIOR ART

Farming implements for decompacting a growing environment of a perennial or annual crop are well known in the state of the art. These implements are devised from a chassis, built with steel beams or tubes, and this chassis is preceded by means for coupling onto a tractor unit, such as a wheeled or crawler tractor, through the hydraulic arms in a third point system or in a single trawl system.

This chassis carries transversally, relative to the displacement direction of the implement, a plurality of tool holder bars, and soil decompacting means are disposed therein, such as scarifying rods, for example.

However, depending on the depth at which the soil is to be decompacted, the need arises to use different implements, the rods and other decompacting elements of which have different characteristics. Accordingly, for more superficial decompaction of the soil, an implement known in the state of the art is used, such as scarifier, which normally has thinner rods and lesser soil turning, relative to an subsoiler implement.

In itself, the use of two different implements generates higher costs to the farmer, and there is also a second drawback relative to the implements known in the state of the art, which is the lack of precision, since the working depth of the decompactor rod is adjusted manually, by hydraulic controls of the tractor unit.

Another drawback of the implements known in the state of the art is the adjustment of the useful working width, which is also performed manually, through the hydraulic controls of the tractor unit, described above.

Accordingly, it is an objective of the present invention to provide an arrangement introduced into a farming implement for decompacting the soil, wherein, from the georeferencing of the growing environment, there are selective adjustments for the working depth of the scarifying rods or other elements active to the soil for decompaction, without the need for manual adjustments by the operator.

It is also an objective of the present invention to provide a mechanism introduced into a farming implement for decompacting the soil, wherein there is an adjustment for the useful working width of the implement, in accordance with pre-set parameters and automatically.

Additionally, it is an objective of the present invention to provide an arrangement introduced into a farming implement for decompacting the soil, wherein the useful width of the crumbling rollers is adjusted automatically in view of the useful working width of the implement.

A final objective of the present invention is to provide an arrangement introduced into a farming implement for decompacting the soil, wherein the active parts of the soil may accompany the curves made by the implement.

### SUMMARY OF THE INVENTION

This and other objectives and advantages are achieved by providing an arrangement introduced into a farming implement for decompacting the soil, endowed with a chassis, built of steel beams or tubes, and said chassis has points for coupling onto a tractor unit, such as a wheeled or crawler tractor, in third point or single trawl systems. Further, this chassis carries sidewardly at least two sections with multiple soil decompacting devices (such as scarifying rods, for example) which have sections pivotable through an eyebolt as the two parts, such that each one of the sections carries a set of ground wheels, and the height of this set is adjusted by a propulsion means, such as a piston of a hydraulic cylinder, a pneumatic cylinder or other well-known means suited for this purpose.

This propulsion means is operatively associated to a sensing means, disposed at points of the decompacting sections, such that this sensing means reads the useful height of the wheelset and sends an analogical or digital signal to a data processor, which has a slot or other means of reading and processing a compaction map of the soil, so that it is adjusted to the ideal depth of the elements active to the soil. Additionally, a second adjustment provides for the regulation of the pivot angle of the sections, providing greater or lesser opening thereof relative to the chassis, equally controlled by a georeferencing system. Lastly, there is a width adjustment system for the crumbling rollers from the position of the implement and of the opening of the sections, where a second propulsion means adjusts the rollers, so they comprise the working width of the decompacting sections of the implement.

In a second embodiment, the set of elements active to the soil, disk and scarifying rod, seated on a fixably mobile support relative to the tool holder bar of the implement, and the support in question carries a crimping point, from a plate at one of its ends, which is secured to the tool holder bar by non-permanent joining means, such as screws and bolts, or permanent means, such as welding seams, wherein these plates have an axis to which a second longitudinal projection plate is coupled, carrying the scarifying rod and the disk, proving a degree of mechanical freedom in a tangential direction, so that the set has a suitable trajectory during steerage of the implement, also enabling vectors to be decomposed from the tangential forces from the displacement of the set.

This generates the accompaniment of the active elements, more specifically the scarifying rods or subsoilers relative to the disks, maintaining a coincidence between the various devices of the machinery or farming implement during the working stage.

### BRIEF DESCRIPTION OF THE DRAWINGS

FIG. 1 is a front perspective view of the arrangement introduced into a farming implement for decompacting the soil, object of the present invention.

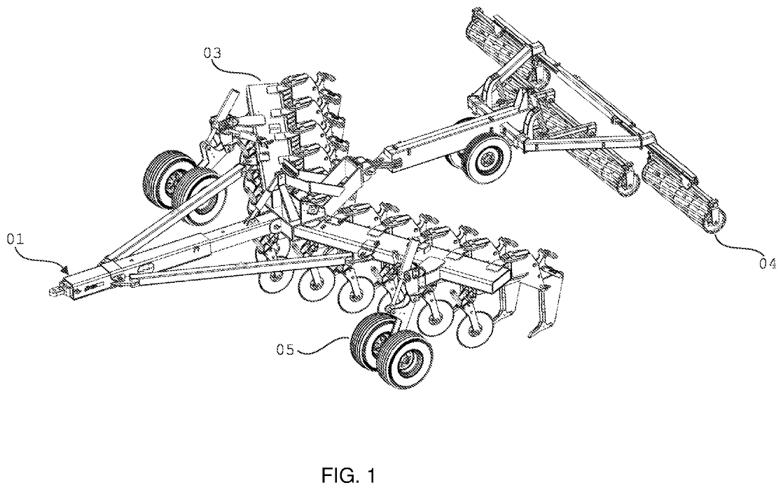

FIG. 2 is a top plan view of the arrangement introduced into a farming implement for decompacting the soil, object of the present invention.

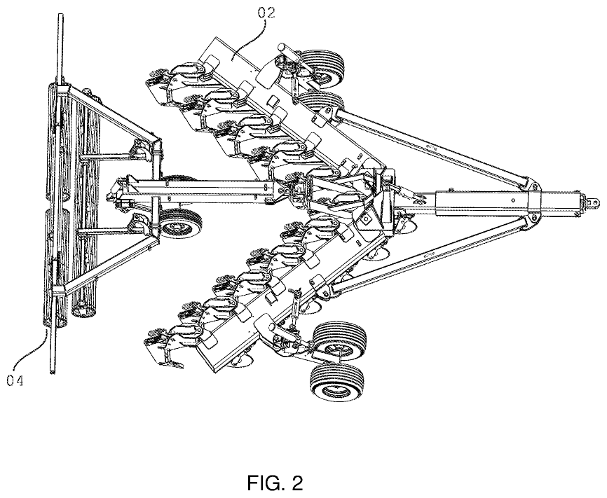

FIG. 3 is a detailed rear perspective view of the crumbling rollers of the arrangement introduced into a farming implement for decompacting the soil, object of the present invention.

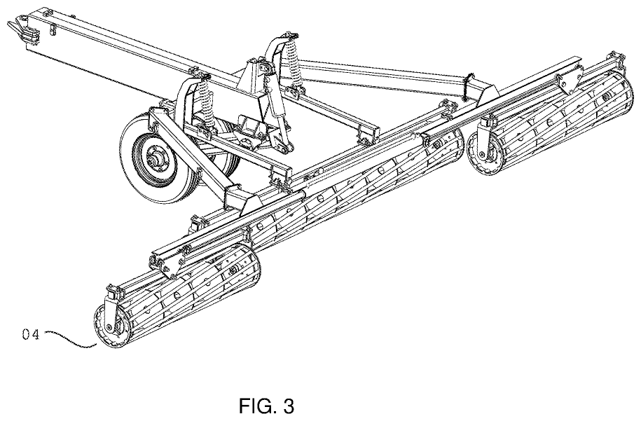

FIG. 4 is a front perspective view, of the arrangement introduced into a farming implement for decompacting the soil, in a second embodiment.

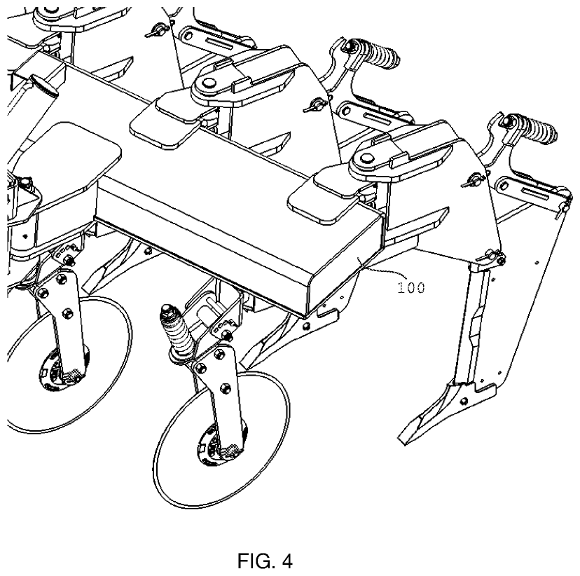

FIG. 5 is a top plan view of the arrangement introduced into a farming implement for decompacting the soil, in a second embodiment.

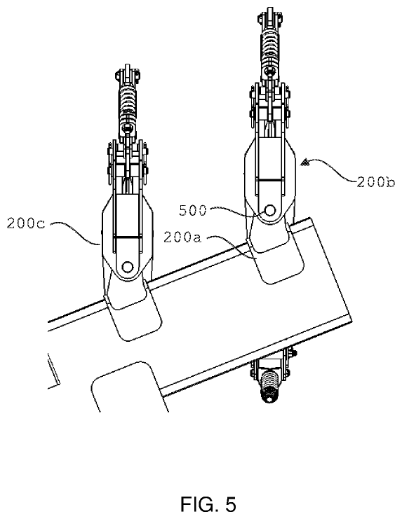

FIG. 6 is a side plan view of the arrangement introduced into a farming implement for decompacting the soil, in a second embodiment.

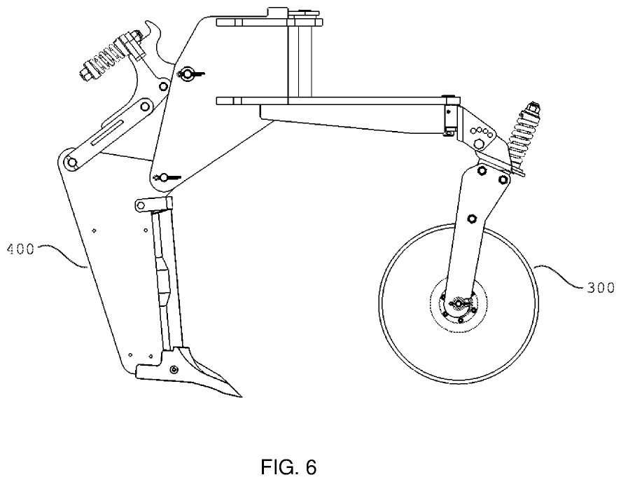

### DETAILED DESCRIPTION OF THE INVENTION

The present invention comprises an arrangement introduced into a farming implement for decompacting the soil, endowed with a chassis (01), built of steel beams or tubes, and this chassis (01) is preceded by means for coupling onto a tractor unit, such as a wheeled or crawler tractor, sidewardly carrying at least one eyebolt (02), on which the sections (03) of the implement are seated by pins or axes, so as to enable degrees of mechanical freedom for the opening and closing of the respective sections relative to the geometric axis of the chassis transversally, and each one of the sections carries at least one set of scarifying rods, disposed at a distance side by side. The chassis (01) further comprises on its end portion supporting means for a set of crumbling rollers (04).

The chassis (01) and the sections (03) of the implement are mounted on a set of ground wheels (05), and these ground wheels have a selective height adjustment, which consequently determines the working depth of the active elements of the implement, such as scarifying rods and disks, through a propulsion means, such as, for example, a hydraulic or pneumatic cylinder or an electro-mechanical actuator, adjustable from a lubricating hydraulic fluid flow control valve.

According to the present invention, a computational means, such as a microprocessor-based electronic control unit, an ECU compatible with the ISOBUS system or other known and suitable means for reading a compaction map of the soil, receives the geographic position of the implement by an antenna in a GPS or DGPS system, for example. Once the coordinate is obtained by the antenna, an algorithm receives, through a data bus, an analogical or digital signal from one or more sensing means, such as inductive or capacitive sensors, such as, for example, photodiode systems or other known and suitable height transducers, which calculate the useful height of the working sections of the implement.

Accordingly, once this information has been processed by a data processor, a signal or electric pulse is sent to a sizing valve of the lubricating hydraulic fluid flow or, alternatively, a pneumatic valve or an electro-mechanical actuator, interoperating as the propulsion means disposed between the chassis and the ground wheels, which according to the drawings represented herein, are hydraulic cylinders and the propulsion means is expanded or retracted so there is a working depth compatible with the compaction rate of the respective map.

The invention now described further has a means of selective opening of the useful width of the sections of the implement, and, according to the input parameter on an interface, the work spacing of the sections of the implement is sized automatically, from propulsion means disposed between the chassis and the sections, on the transversal plane, from of the degree of mechanical freedom provided by the eyebolts (02), described above.

Once the work spacing of the implement has been sized, the crumbling rollers (04) are selectively adjusted so they can operate at the same useful width for preparing the land. Accordingly, a propulsion means is sized for the retreat or expansion of the rollers, from telescopic supports, and these propulsion means can be electromechanical devices, such as, for example, electro-mechanical actuators, hydraulic or pneumatic cylinders, controlled from linear encoder systems or other means of controlling the position of a rod of a linear displacement means, but not limited to the various optical technology systems, wherein the light is generated by LED and detected by a chip-type sensor. Between the two there is a coded bar, typically made of glass, metal or plastic. In an incremental encoder, the coded bar is engraved, coated or drilled onto the metal with the fine grid of similar lines along its path.

Although the various interfaces between the sensing and propulsion means are not described in detail or represented in the drawings, it should be understood that the interfaces known in the state of the art can be employed, as currently used in the diverse tractor units, operatively associated to the implements, and these interfaces in isolation are not within the scope of the present invention.

A second embodiment of the arrangement introduced into a farming implement for decompacting the soil comprises a tool holder bar (100), which carries at least one support (200a) for each soil preparing device (200b), comprised of a cutting disk (300) and a scarifying rod (400). Said support (200a) is secured to the tool holder bar (100), through permanent joining means, such as welding seams, or non-permanent joining means, such as screws fastened to the respective tool holder bar. This soil preparation set already described further has elastic means to compress the set to the ground, such as helical springs, being mounted on a second support (200c), built of steel plate or tube, from where an axis (500) projects, overlapping the support (200a), providing a degree of mechanical freedom for the soil preparation set described above, whereby enabling the set to oscillate at an angle relative to the geometric axis of the fastening points of the two parts.

Therefore, in working stage, the construction described above enables the soil preparation set to be displaced from a linear to a slanted position, such that, during the steerage of the implement, the elements active to the soil accompany its path without the need to raise the respective active elements, through the hydraulic cylinder or other known and suitable propulsion means, now described in the main application.

It should be understood that the preferred embodiments mentioned here are merely illustrative of the present invention. Numerous variations in design and use of the present invention may be contemplated in view of the following claims without straying from the intended scope and field of the invention herein disclosed.

1. A farming implement for decompacting soil, comprising a farming implement couplable to a tractor unit, endowed with a chassis carrying at least two sections, pivotable by an eyebolt, relative to each other, wherein the sections have working height sensing means, such as a set of electrically excited, inductive, capacitive or optical sensors, which interoperate with a computational means endowed with a georeferenced position system, such as a GPS or DGPS system and at least one slot or other means of reading a soil compaction map, which determines selective opening and closing, through flow-sizing valves of a propulsion device, such as a hydraulic or pneumatic cylinder, disposed on the set of ground wheels of the implement, as well as a second propulsion device identical to the one described above, which adjusts the opening and the closing of the working angle of the sections.

2. The farming implement according to claim 1, wherein the propulsion means is an electro-mechanical actuator, controlled by an electronic circuit, operatively associated to an interface endowed with a soil compaction map, which sizes the expansion or retraction of its free rod.

3. The farming implement according to claim 1, wherein the crumbling rollers have a selective opening through a propulsion means, whose free rod expansion occurs in a manner controlled by electronic means, such as a linear encoder.

4. A farming implement comprising a tool holder bar, carrying at least one support for each soil preparing device, mounted on a second support, wherein the support is pivotable by means of an overlapping axis common to the two parts.
